(19) United States
(12) Patent Application Publication
(10) Pub. No.: US 2010/0205810 A1
(43) Pub. Date: Aug. 19, 2010

(54) Household Press

(76) Inventor: Helge Kossol, Hannover (DE)

Correspondence Address: ROBERT W. BECKER & ASSOCIATES, 707 HIGHWAY 333, SUITE B, TIJERAS, NM, 87059-7507, US

(21) Appl. No.: 12/670,107

(22) PCT Filed: Jun. 26, 2008
(86) PCT No.: PCT/DE08/01068

§ 371 Date: Feb. 8, 2010

(30) Foreign Application Priority Data
Jul. 23, 2007 (DE) 10 2007 034 208.1

(51) Int. Cl. A47J 43/26

(52) U.S. Cl. 30/120.2; 99/582

(57) ABSTRACT

A household press for material that is to be pressed, comprising a nut and a screw. The nut has a head part in the shape of a hollow cylinder. One end of the nut part is delimited by a base and an opposite end continues as a coaxially extending half shell having an internal thread provided with an undercut. The screw has a base at one end and a threaded part delimited by the base, with a thread of the threaded part having an undercut. A grip part adjoins the threaded part remote from the screw base. The threaded part can be placed into the thread of the nut to form a receiving chamber between the bases. The receiving chamber is closed down or shortened upon rotation of the nut and screw relative to one another.

The present invention relates to a household press pursuant to the introductory portion of claim 1.

DE 66 00 726 U discloses a device for breaking nuts open and has a collection device for nut shells and nut kernels. It comprises a circular ring having a concave inner surface, with the upper region of the ring having passing therethrough, in the radial direction, a threaded hole for receiving a screw. The outer end of the screw is provided with a toggle and carries a concave, rotatable disk at that end that is disposed in the ring. The ring is secured to a plate, which is divided into two partitions for receiving parts of nut kernels and nut shells. The drawback of this design is that the nut that is to be placed between the concave surfaces of ring and disk must be held by the thumb and pointer finger until it is fixated after appropriate rotations of the toggle. A further drawback is the inconvenient and uncomfortable handling of the toggle.

De 35 33 970 C2 describes a device for the cracking or crushing of nuts that is embodied as a screw box. The two halves of the box are adjustable in the axial direction relative to one another by means of two thread connections. One of these connections is formed by a movement thread having play in both the axial and radial directions. After the nut is placed into the opened box, the upper half of the box is screwed down onto the nut by the means of this thread. Further turning to break the nut with this thread is not possible due to the high expenditure of force required to do so, so that further rotation is transferred to the other thread connection having a normal pitch. After the start of the cracking of the nutshell, it is completely cracked by tilting the box halves against one another, whereby the stroke of the tilting movement is delimited by the play of the movement thread such that the nut cannot be completely crushed. The construction of this household press is described in many variations, the construction of which, which is comprised of a plurality of parts, is very expensive for all of the illustrated embodiments. Since to place the nut in, the upper half of the box must be completely unthreaded from the bottom half, use of this household press is very time consuming. However, the advantage here over the above-cited design of DE 66 00 726 U is that during breaking of the nutshell the parts of the shell are contained and do not fly around in an uncontrolled manner.

In DE 36 24 733 C2, in a further embodiment of the device according to DE 35 33 970 C2, it is shown how, by arresting means disposed on one of the box halves, the spacing of the box halves relative to one another can be adjusted in adaptation to the size of the nut that is to be broken.

DE 197 33 551 C2 shows a household press for the cutting of garlic and has the following construction: an outer housing, which is open toward the bottom, carries a transversely disposed cutting blade in its lower region. The upper housing termination is formed by a cover that can be threaded on and that in turn has an internal thread. Disposed in the outer housing is a rotatably mounted inner housing having a rectangular inner space and a cutting grid that is disposed on the underside thereof and that upon rotation of the housings relative to one another cooperates with the cutting blade. Accommodated in the rectangular inner space is a rectangular stamp that on its underside is embodied as a pressing part and that represents a counter piece that cooperates with the cutting grid. With this it forms the receiving space for the material that is cut. At its upper region, the stamp merges into a sleeve having an outer thread and ending toward the top in a hand wheel. The outer thread of the sleeve runs in the inner thread of the screwed-on cover. For the placement of the material that is to be cut, the cover is unscrewed from the outer housing and is pulled upwardly together with the stamp. After placing the material that is to be cut onto the cutting grid, the cover is again screwed on. By turning the hand wheel, with the outer housing being held firmly, the stamp is moved downwardly, and at the same time the cutting grid rotates over the cutting blade. This cuts the spikes or pieces of material emerging from the cutting grid into small cubes. The construction of this household press is very complex, and its use as well as its cleaning is relatively cumbersome. In this connection, there is, however, the advantage that the cut material does not exit in spike form or even squashed, but rather is processed into cubes.

U.S. Pat. No. 1,248,313 A describes a nutcracker. It is comprised of three parts, a nut part, a screw part and a base part. The base part is a one-piece shaped sheet metal part having a sleeve-like shaft that merges into an open shell portion, from the end of which a base projects at right angles. The sleeve-shaped shaft of the base part has an axial slot that is open toward the base and that is provided with teeth on one edge. The nut part can be introduced into the shaft of the base part and has on the outer side a raised portion with teeth that can engage the teeth of the shaft. For this purpose a pin projects from the raised portion and through the slot of the shaft. By means of this pin, the nut part can be rotated such that its teeth are in engagement with the teeth of the shaft or are not in engagement. The nut part has an internal thread into which the screw part can be threaded. The screw part has a plate on its end that faces the base 5 of the base part. This plate, together with the base of the base part, delimits a receiving space for a nut. A toggle is provided on the other end of the screw part, with the aid of which the screw part can be rotated. This known nutcracker has the advantage that the screw part does not have to be threaded through a free play to adapt to different nut sizes. To adapt the nutcracker to a nut size, the nut part is first rotated such that its teeth come out of engagement with the teeth of the base part. The screw part, without having to be rotated, can then be axially adjusted to the respective nut size. After placing the plate of the screw part onto the upper surface of the nut, the nut part is again rotated such that its teeth engage the teeth of the shaft. The nut part is now secured relative to the base part, and by rotating the screw part an axial force can be applied to the nut, which eventually leads to breaking of the nutshell.

The object of the present invention is to provide a household press of the aforementioned general type such that the construction thereof is simplified, the handling is simple and saves time and cleaning can be undertaken without problem.

This object is inventively realized by the features of claim 1. Advantageous and expedient further developments are provided in the dependent claims.

The present invention is characterized in that the basic form of the household press is comprised of only two parts, namely a screw and a nut. In this form, the base of the nut forms a closed surface, so that in this basic form the press can preferably be used to break the nut.

The nut is comprised of a hollow cylinder with a closed base at one end and a half shell-shaped part that adjoins the other end. On its inner surface, the half shell has a trapezoidal thread, the thread profile of which is inclined in the direction of the base, so that an undercut results that flank of the thread that faces the base. The thread can fill the entire inner surface of the half shell, or can have a cut-out in its central region disposed in the longitudinal direction. With the thereby resulting interruption of the thread, its jamming due to penetration of residue of shells or nut kernels, or the residue of other pressed or processed material, is reduced. The free space disposed between the thread segments accommodates these residues during rotation of the screw. The inventive configuration facilitates cleaning of the household press.

The screw is comprised of a threaded part having an adjoining cylindrical grip part. It preferably has a hollow configuration, whereby a base at the end of the threaded part closes off one end of the hollow cylinder. The thread corresponds to that of the nut, whereby the incline of the thread profile is directed in the other direction, in other words, forms an undercut on that flank of the thread that faces away from the base of the screw.

For use, the nut that is to be cracked is placed at the base of the nut, and the threaded part of the screw is placed upon the threaded part of the nut. In so doing, the screw slides over the inclines of the thread profile a little bit in the direction of that side facing away from the base of the nut, until it rests fully in the nut thread. The bases of screw and nut now form, together with the hollow cylinder of the nut, a chamber that surrounds the nut. For the central centering of the nut, the two bases can have a concave configuration.

By rotating the hand grip of the screw, the base of the screw moves onto the nut and eventually cracks it, whereby the chamber ensures that when the nut is broken open, no shell parts can fly away. To remove the broken nut, the screw is turned back until it is free floating relative to the head part of the nut, whereafter it can be removed from the nut.

When the screw exerts pressure onto the base of the nut, either directly or via material that is to be pressed, for example a nut, that has been placed in, there results a unit that is comprised of two parts and is generated by pressing, the parts of the unit again being separated by turning the screw back.

By the configuration that is selected for the thread there is ensured that during the cracking process the screw cannot lift out of the nut: the surfaces of the undercuts that rest against one another produce, when an axial load is applied, a radial force component that holds the screw in the nut.

By configuring the household press with the base of the nut in a different form than the closed form, for example as an apertured plate or cutting grid, it can alternatively be used as a press or cutting device for other material that is to be pressed, such as garlic, onions or the like.

If a cutting grid is used, mounting a rotatable plate at the base of the screw has an advantage in that upon rotation of the screw, the material to be cut is not carried along and can thus be processed to form spikes or pieces that as they are formed are not sheared off by the carry-along effect of the rotating screw base.

Pursuant to a further embodiment, the respective base is configured as a replacement or exchangeable base, which converts the household press into a true universal device.

Independently of the above described embodiments, the individual parts of the household press, whether they are made of polymeric material of metal, can be cleaned without difficulty, for example in the silverware tray of a dishwasher.

The invention will be described in greater detail subsequently with the aid of the accompanying drawings, which illustrate an embodiment having different variations and in which:

FIG. 1: is a side view onto a screw of an inventive household press,

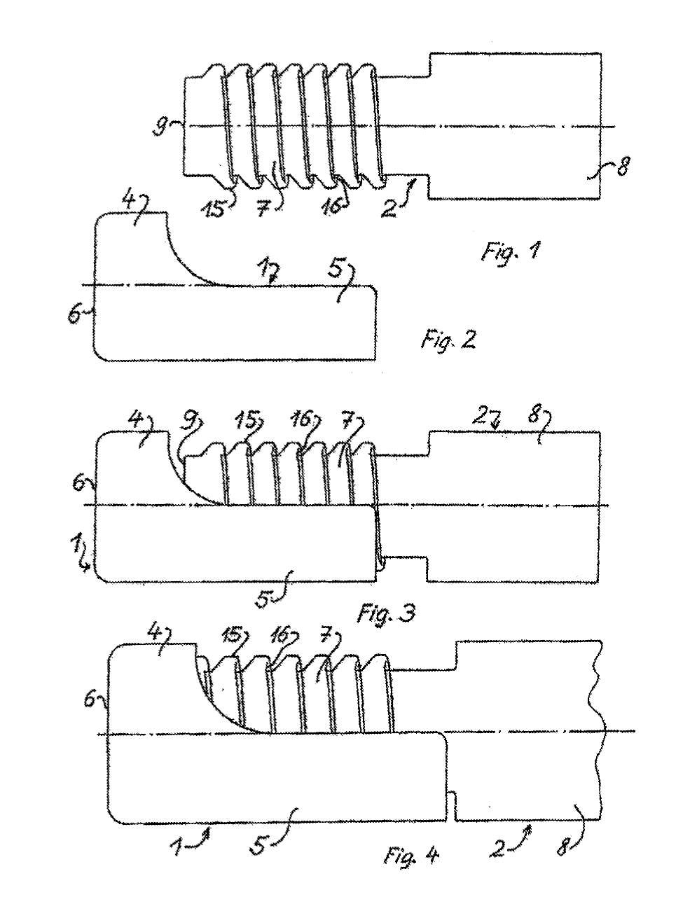

FIG. 2: is a side view onto a nut of an inventive household press,

FIG. 3 is a side view of the nut of FIG. 2 with the screw inserted,

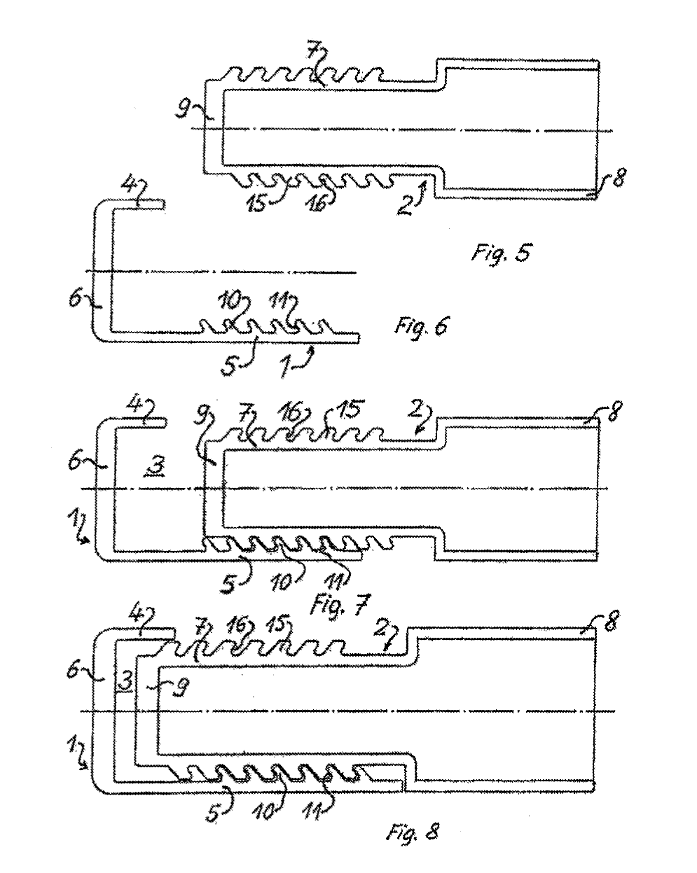

FIG. 4 is a side view onto the nut of FIG. 2 or 3 with the screw threaded in,

FIG. 4 is a longitudinal section through the screw of FIG. 1,

FIG. 6 is a longitudinal section through the nut of FIG. 2,

FIG. 7 is a longitudinal section through the device of FIG. 3,

FIG. 8 is a longitudinal section through the device of FIG. 4,

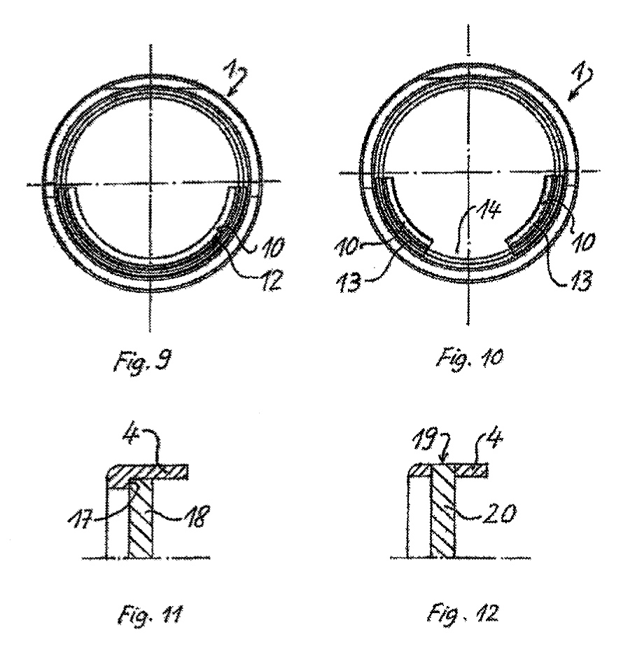

FIG. 9 is a view from the right onto the nut of FIG. 2,

FIG. 10 is a view of a further embodiment in conformity with the viewing direction of FIG. 9,

FIG. 11 is a partial longitudinal section through the left, upper region of the nut of FIG. 2, and

FIG. 12 is a partial section, in correspondence with FIG. 11, of a further embodiment.

The same and corresponding parts of the household press are provided with the same reference numerals in the figures.

The drawings show a household press comprised of a nut 1 to and a screw 2.

The nut 1 is comprised of a head part 4, which is embodied as a hollow cylinder and is closed off at one end by a base 6. The portion of the head part 4 disposed opposite the base 6 mergers coaxially into a half shell 5 in its lower region, whereby the transition from the upper end of the head part 4 that faces away from the base extends in a radius-shaped manner in the direction of the half shell 5, and opens out into the upper sides of the half shell 5. Formed on the inner surface of the half shell 5 is a trapezoidal thread 10, the profile of which is inclined in the direction toward the base 6, so that on that flank of the thread 10 that faces the base 6, an undercut 11 results. As shown in FIG. 9, the thread 10 of the half shell 5 can be embodied as a peripheral segment 12 that fills the half shell 5, or, pursuant to FIG. 10, the thread can form two segment portions 13 that form a free space 14 located between them.

The screw 2 is formed of a threaded part 7, which at one end ends in a bottom or base 9, and at the other end is adjoined by a cylindrical grip part 8. The screw 2 is preferably embodied as a hollow cylinder, but depending upon the material that is selected can also be embodied as a solid cylinder. The thread 15 of the screw 2 corresponds to the thread 10 of the nut 1, whereby the profile of the thread 15 is inclined in the other direction. In so doing, the flank of the thread 15, on that side facing away from the base 9 of the screw 2, forms an undercut 16.

The bases 6, 9 of the nut 1 and the screw 2, together with the head part 4, form a receiving chamber 3 and can have a concave configuration for the centering of the material that is to be pressed or otherwise handled.

The nut 1 and the screw 2 can be made of metal or polymeric material. A composite of the two materials is also possible, for example as a shell or sleeve that carries the thread 10, 15, and that is incorporated into the main body of the nut 1 and screw 2.

In the further embodiment pursuant to FIG. 11, the base 6 of the nut 1 is replaced by an annular shoulder 17. A base insert 18 that delimits the receiving chamber 3 in the axial direction can be placed against this shoulder.

An alternative embodiment to that of FIG. 11 is illustrated in FIG. 12. While leaving out the base 6, the upper half of the head part 4 of the nut 1 is provided with a slot 19 into which a slide-in base 20 can be inserted. The lower half of the slot 19 can be embodied as a groove, whereby the slide-in base should have a corresponding contour.

A further alternative to the solutions shown in FIGS. 11 and 12 can be a cover that is secured to the end face of the head part 4 of the nut 1 by means of a screw connection or a bayonet closure, whereby also here the base 6 of the nut 1 is left out (no illustration).

To break material that is to be pressed, for example nuts, the base insert 18, the slide-in base 20, and the cover can have a closed structure. To press material such as garlic or onions, they are embodied as an apertured plate. To cut garlic or onions, they are embodied as a cutting grid. In cooperation with the cutting grid, it is advantageous to dispose a rotatable plate at the base 9 of the screw 2.

### REFERENCE NUMERAL LIST

1. Nut
2. Screw
3. Receiving Chamber
4. Head part
5. Half shell
6. Base
7. Threaded part
8. Grip part
9. Bottom or base
10. Thread
11. Undercut
12. Segment
13. Segment portion
14. Free space
15. Thread
16. Undercut
17. Shoulder
18. Base insert
19. Slot
20. Slide-in base

1-18. (canceled)

19. A household press for material that is to be pressed, comprising:
a nut having a head part that is in the shape of a hollow cylinder, wherein one end of said head part is delimited by a base, further wherein an opposite end of said head part continues as a coaxially extending half shell, further wherein a thread is disposed on an inner surface of said half shell, and wherein an undercut is provided on said thread of said half shell; and
a screw having a base one end, wherein said screw includes a threaded part that is delimited by said base of said screw and is provided with a thread, further wherein an undercut is provided on said thread of said threaded part, further wherein a grip part adjoins said threaded part remote from said base of said screw, further wherein said threaded part is configured to be placed into said thread of said nut such that a receiving chamber is formed between said base of said nut and said base of said screw, and wherein said receiving chamber is adapted to close down or shorten upon rotation of said nut and said screw relative to one another.

20. A household press according to claim 19, wherein said threads of said nut and of said screw are trapezoidal threads.

21. A household press according to claim 19, wherein said thread of said nut has a profile that is inclined in the direction of said base of said nut, so that said undercut is formed on a flank of said thread of said nut that faces said base of said nut.

22. A household press according to claim 21, wherein said thread of said screw has a profile that is inclined in the direction of said grip part, so that said undercut is formed on a flank of said thread of said screw that faces said grip part.

23. A household press according to claim 19, wherein said thread of said nut is formed from two segment portions that extend in a longitudinal direction and provide a free space between them.

24. A household press according to claim 19, wherein a transition from said head part of said nut into said half shell extends from an upper end of said head part that faces away from said base of said nut in a radius-shaped manner in the direction of said half shell, and wherein said radius-shaped transition opens out into upper sides of said half shell.

25. A household press according to claim 19, wherein said receiving chamber is a closed receiving chamber formed by said base of said screw and said base as well as said head part of said nut.

26. A household press according to claim 19, wherein said screw forms a hollow cylinder that is open at an end of said grip part.

27. A household press according to claim 19, wherein facing surfaces of said bases of said nut and said screw have a concave configuration.

28. A household press according to claim 19, wherein said nut and said screw are made of metal.

29. A household press according to claim 19, wherein said nut and said screw are made of polymeric material.

30. A household press according to claim 19, wherein said nut and said screw are made of a combination of metal and polymeric material.

31. A household press according to claim 30, wherein regions of said threads of said nut and said screw are made of metal, and wherein the remaining portions of said nut and said screw are made of polymeric material.

32. A household press according to claim 19, wherein said base of said nut is embodied as an annular shoulder against which a base insert can be placed from an inner side of said head part.

33. A household press according to claim 19, wherein in place of said base of said head part of said nut, a slide-in base is provided that is adapted to be inserted into a slot provided in an upper half of said head part.

34. A household press according to claim 19, wherein in place of said base of said head part of said nut, a cover having an internal thread is provided for closing off said head part by being threaded onto an external thread provided on an end of said head part.

35. A household press according to claim 32, wherein said base insert has a closed structure, or is embodied as an apertured plate, or is embodied as a cutting grid.

36. A household press according to claim 33, wherein said slide-in base has a closed structure, or is embodied as an apertured plate, or is embodied as a cutting grid.

37. A household press according to claim 34, wherein said cover has a closed structure, or is embodied as an apertured plate, or is embodied as a cutting grid.
